(19) United States
(12) Patent Application Publication
(10) Pub. No.: US 2007/0115987 A1
(43) Pub. Date: May 24, 2007

(54) Translating network addresses for multiple network interfaces

(76) Inventor: G. J. Hoekstra, Amersfoort (NL)

Correspondence Address: WILLIAMS, MORGAN & AMERSON, 10333 RICHMOND, SUITE 1100, HOUSTON, TX, 77042, US

(21) Appl. No.: 11/265,006

(22) Filed: Nov. 2, 2005

(51) Int. Cl. H04L 12/56

(52) U.S. Cl. 370/392; 370/401

(57) ABSTRACT

The present invention provides a method for translating network addresses for multiple network interfaces. The method includes accessing information indicative of a plurality of first addresses associated with a plurality of first network interfaces and forming a second address associated with the plurality of first addresses.

### BACKGROUND OF THE INVENTION

1. Field of the Invention

This invention relates generally to communication systems, and, more particularly, to translating network addresses for multiple network interfaces in communication systems.

2. Description of the Related Art

Each terminal in a communication network includes a network interface, which may be used to form a network connection with one or more other terminals. Network connections form a logical association between connected terminals and the network connections between the terminals may be initiated and/or terminated on the network interface of the terminals. For example, FIG. 1A conceptually illustrates a communication network 100 including first and second terminals 105(1-2). The first terminal 105(1) may exchange information with the second terminal 105(2) over a network connection 110, which terminates at the network interfaces 115(1-2) of the first and second terminals 105(1-2). The first and second terminals 105(1-2) each have a network address associated with their network interface 115(1-2). The network connection 110 may operate according to any desirable wired and/or wireless protocol, such as an Internet protocol, a Universal Mobile Communications System (UMTS) protocol, an IEEE 802.11 protocol, a Bluetooth protocol, and the like.

FIG. 1B conceptually illustrates functional layers within the first and second terminals 105(1-2). Each terminal 105(1-2) includes an application layer 120(1-2) and a transport layer 125(1-2). The application layers 120(1-2) may interact with each other, as indicated by the dashed line 130. Accordingly, the transport layers 125(1-2) may include functionality to assure that the application layers 120(1-2) are able to interact. The application layers 120(1-2) and the transport layers 125(1-2) may exchange information using Service Data Units (SDUs). The transport layers 125(1-2) may interact with each other through the network interfaces 115(1-2), as indicated by the dashed line 135. The transport layers 125 (1-2) and the network interfaces 115 (1-2) may interact with each other by exchanging Network Data Units (NDUs). No interaction is indicated between the network interface layers 115 (1-2) because implementation of these layers may differ. For example, the terminal 105(1) may use a different network technology than the terminal 105(2).

Bottlenecks may form in the communication network 100. For example, the application 120(1) may need to receive a large amount of data from the application 120(2). over the network connection 110. However, the data transfer rate may be limited by the throughput of one or both of the network interfaces 115(1-2), which may result in delays in receiving the data. For another example, multiple applications (not shown) in the terminals 105(1-2) may use a single network interface 115(1-2) to transmit and/or receive data over the network connection 110. Bottlenecks may then form as the multiple applications compete for capacity to receive and/or transmit data over the network connection 110. Many techniques have been proposed to increase the capacity of conventional wireless communication networks.

Throughput of the communication network 100 may be increased at the physical layer. Capacity may be increased by enhancing modulation schemes, media access control, and/or the transmission and/or reception capacity. For example, channel bonding has been used to increase the capacity of wireless local area networks. In channel bonding, multiple radiofrequency channels are combined to form a single logical channel with a higher capacity. For another example, multiple channels formed with the multiple antennas used in Multiple-Input-Multiple-Output (MIMO) systems may be combined to form one relatively large capacity channel. The single logical channel is administered by an associated network interface. Although combining channels to form a single channel may lead to large capacity gains, the physical circumstances must meet certain conditions. For example, MIMO systems perform well in a rich scattering environment, but may not perform as well in low scattering environments.

The capacity of the communication network 100 may also be increased by modifying one or more application layers 120(1-2). For example, peer-to-peer (P2P) programs such as eDonkey and Kazaa can download a file that has been divided into multiple file segments. The file segments may be downloaded from different servers in parallel over a single network interface. The file segments are then combined to restore the original file. The functionality for achieving the performance improvement resides at the application layer 120 (1-2). Lower-level functional layers, such as the transport layer 125(1-2), operate as if multiple applications are receiving the file segments. However, application-level modifications may still be limited by the capacity of the network interface 115(1-2).

Modifications to a data link layer may also be used to increase capacity of the communication network 100. For example, MultiNet is a virtualization architecture for wireless local area network cards that may enable a user to connect his or her machine to multiple wireless networks using a single wireless local area network card, i.e. a single network interface. In operation, MultiNet exposes multiple virtual adapters for each underlying wireless network card. A network hopping schemes then switches the wireless card across the desired wireless networks, each of which may provide a separate network stream. However, MultiNet may become unstable and oscillate between the network streams, at least in part because MultiNet maps a single transport session associated with a single network interface on to multiple network streams.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for translating network addresses for multiple network interfaces. The method includes accessing information indicative of a plurality of first addresses associated with a plurality of first network interfaces and forming a second address associated with the plurality of first addresses.

In another embodiment of the present invention, a method is provided for translating network addresses for multiple network interfaces. The method includes forming a plurality of first addresses associated with a plurality of first network interfaces using a second address.

### BRIEF DESCRIPTION OF THE DRAWINGS

The invention may be understood by reference to the following description taken in conjunction with the accompanying drawings, in which like reference numerals identify like elements, and in which:

FIG. 1A conceptually illustrates a conventional wireless communication network including first and second terminals;

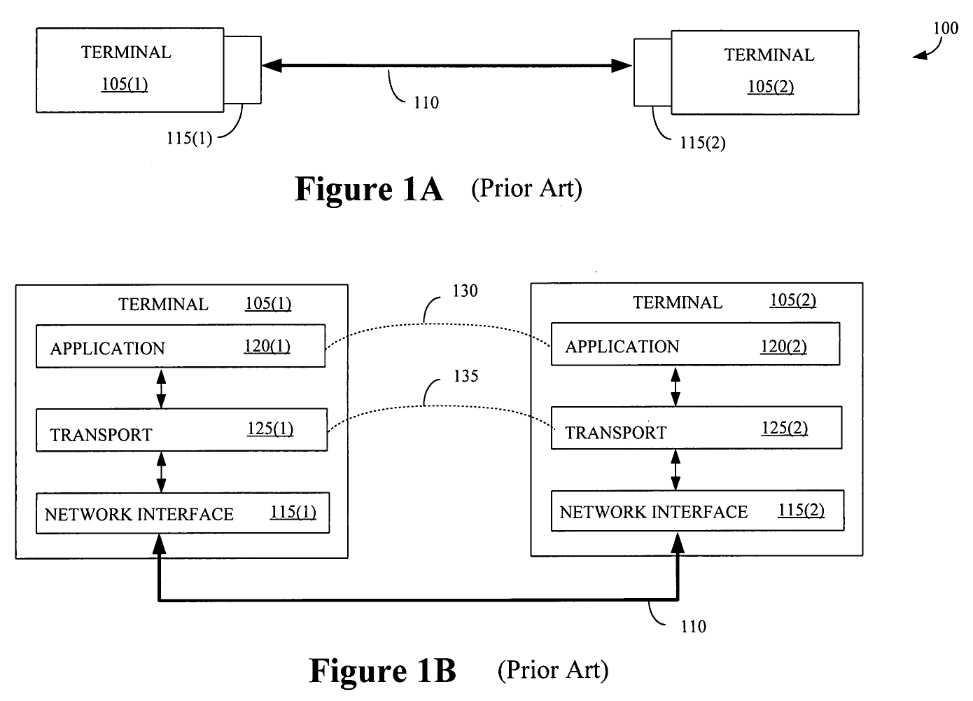

FIG. 1B conceptually illustrates functional layers within the conventional terminals shown in Figure IA;

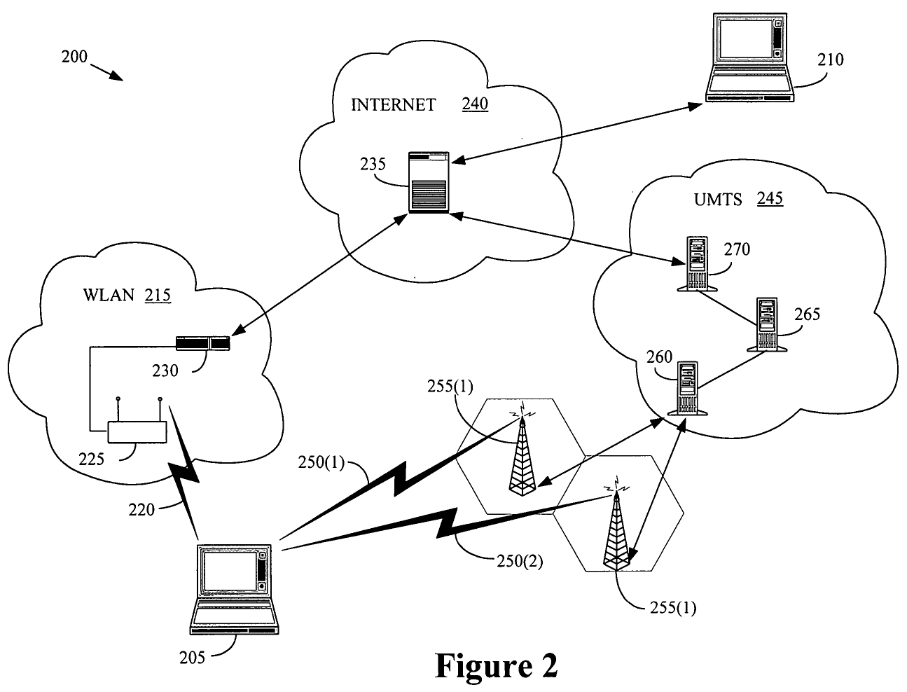

FIG. 2 shows one exemplary embodiment of the wireless communications system, in accordance with the present invention;

FIGS. 3A, 3B, and 3C conceptually illustrate three exemplary embodiments of wireless communication systems that allow one or more terminals to form a virtual network connection using a plurality of network connections via a plurality of network interfaces, in accordance with the present invention;

FIG. 4 conceptually illustrates one exemplary embodiment of a terminal that may be used in the wireless communication systems shown in FIGS. 2 and 3A-B, in accordance with the present invention;

FIG. 5 conceptually illustrates a first exemplary embodiment of a communication system, in accordance with the present invention;

FIG. 6 conceptually illustrates a second exemplary embodiment of a communication system, in accordance with the present invention; and

FIG. 7 conceptually illustrates a third exemplary embodiment of a communication system, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

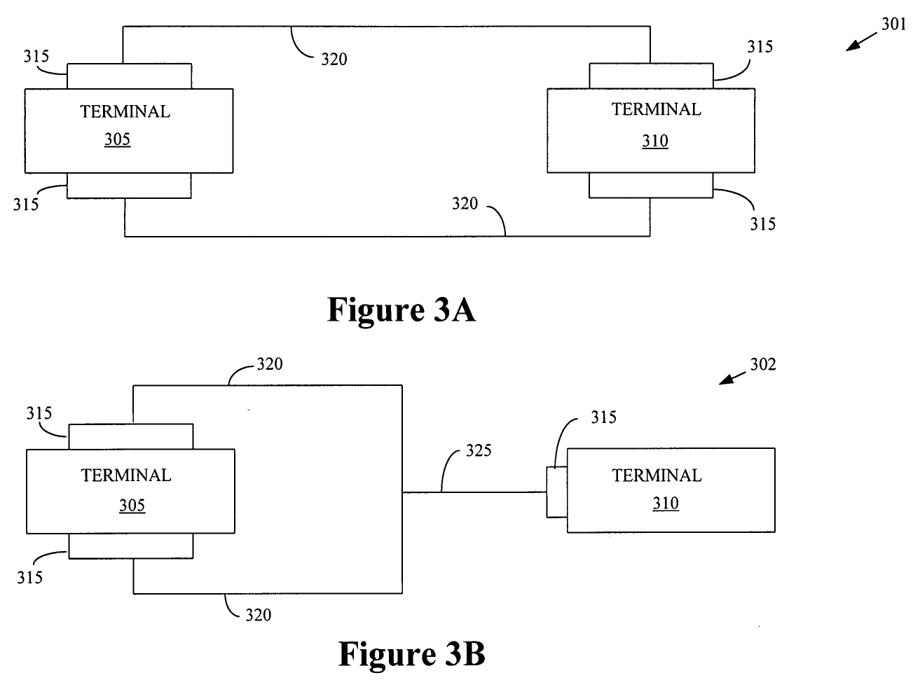

Referring now to FIG. 2, one exemplary embodiment of a wireless communications system 200 is shown. Although the present invention will be described in the context of the wireless communications system 200, persons of ordinary skill in the art having benefit of the present disclosure should appreciate that the present invention is not limited to wireless communications systems. In alternative embodiments, the present invention may be implemented in wired communications systems or systems that include a combination of wired and wireless technologies.

In the illustrated embodiment, the wireless communication system 200 may be used to form a network connection between the terminals 205, 210. The terminals 205, 210 may be any desirable device capable of exchanging information via the wireless communication system 200. Exemplary terminals 205, 210 include, but are not limited to, mobile phones, personal data assistants, text messaging devices, wireless cards, laptop computers, desktop computers, and the like. As used herein, the term “termninal” refers to any device that terminates a network connection. Accordingly, the terminals 205, 210 may also include devices such as access points, base stations, node-Bs, servers, network controllers, and the like. In various embodiments, the wireless communication system 200 may include any desirable number of terminals 205, 210.

The terminal 205 includes a plurality of network interfaces (not shown in FIG. 2). As used herein, the term “network interface” refers to the software and/or hardware used to define one or more network primitives that enable the terminal 205 to communicate over a particular network using a specific network technology. For example, network interfaces may be used to define network primitives for communication over a local area network (LAN), a wireless local area network (WLAN), a Universal Mobile Telecommunication System (UMTS) network, a Global System for Mobile communications (GSM) network, and the like. The network interface enables communication between devices, such as the terminal 205, via the associated network. The network interface may use network protocols to route packets from source to destination, and different network interfaces may utilize different network protocols. Accordingly, in some embodiments, a converter (not shown) that transforms the protocol information may be used to realize end-to-end network layer communication. The network interface also terminates the associated network technology and converts lower layer information and associated data to a form that may be used by higher layers. For example, a network interface may convert physical layer information and associated data to transport and/or application layer information using a data link layer. In some embodiments, the network interface may include one or more physical interfaces (e.g. an antenna and/or a connector), as well as one or more data link layer protocols, which may transform information into physical signals (and vice versa) that appear free of transmission errors. The terminal 210 also includes one or more network interfaces.

The plurality of network interfaces in the terminal 205, as well as the one or more network interfaces in the terminal 210, enables the terminal 205 to form one or more concurrent network connections with the terminal 210 using one or more networks. In the illustrated embodiment, the terminal 205 includes at least one network interface that enables the terminal 205 to communicate with a wireless local area network (WLAN) 215 via an air interface 220. The air interface 220 may operate according to any desirable protocol including, but not limited to, a Bluetooth protocol and/or an IEEE 802.11 protocol. Accordingly, the terminal 205 may communicate with an access point 225 that may be connected to a router 230. The router 230 may provide a communication link to a server 235 in a wired and/or wireless network such as an Internet 240. The server 235 may form a communication link that completes the network connection to the terminal 210.

The terminal 205 may also include one or more network interfaces that enable the terminal 205 to communicate with a Universal Mobile Communication System (UMTS) network 245. In the illustrated embodiment, the terminal 205 includes a plurality of network interfaces that enable the terminal 205 to form one or more air interfaces 250(1-2) with one or more node-Bs or base stations 255(1-2). One or more of the base stations 255(1-2) may then communicate with a radio network controller 260, which may communicate with the server 235 in the Internet 240 via a Gateway General Packet Radio Service (GPRS) Support Node (GGSN) 270 and a Serving GPRS Support Node (SGSN) 265. As noted above, the server 235 may form a communication link that completes the network connection from the terminal 205 to the terminal 210. In some embodiments, the communication link from the terminal 205 to the terminal 210 may be formed of several segments, each of which may include one or more network connections.

Although the wireless communication system 200 shown in FIG. 2 includes a wireless local area network 215 and a UMTS network 245 in communication with the Internet 240, persons of ordinary skill in the art should appreciate that the present invention is not limited to this specific embodiment. In alternative embodiments, the wireless communication system 200 may include more or fewer networks of any desirable type. For example, the wireless communication system 200 may only include the UMTS network 245, in which case the terminal 205 may include a plurality of network interfaces for communicating with the UMTS network 245 over a plurality of communication channels. For another example, the wireless communication system 200 may include additional wired and/or wireless networks, such as an Internet, one or more intranets, a Global System for Mobile communications (GSM) network, a Public Data Network (PDN), an IEEE 802-type network, a Bluetooth network, and the like.

The terminal 205 is capable of using the plurality of network interfaces to establish concurrent network connections with the terminal 210 using more than one of the network interfaces. For example, the terminal 205 may use a WLAN network interface and a UMTS network interface to form concurrent network connections with the terminal 210 over the air interface 220 and the air interface 250(1). For another example, the terminal 205 may use multiple UMTS network interfaces (or multiple instances of a UMTS network interface) to form concurrent network connections with the terminal 210 over the air interfaces 250(1-2). In one embodiment, the multiple network interfaces may be used for both uplink and downlink communications. However, in alternative embodiments, a dedicated transmission network interface may be used for uplink communications and a dedicated reception network interface may be used for downlink communications. Persons of ordinary skill in the art having benefit of the present disclosure should appreciate that the number and/or type of network interfaces used to form the network connections, as well as the partitioning of uplink and/or downlink communications, are matters of design choice. Moreover, the number and/or type of network interfaces used to form the network connections, as well as the partitioning of the uplink and/or downlink communications, may vary during operation of the wireless communication network 200.

The network connections formed through the network interfaces can be used to provide network connectivity to hardware and/or software in an application layer of the terminal 205. In accordance with common usage in the art, the term “application layer” will be used herein to refer to a layer that supports application and/or end-user processes. In various embodiments, the application layer may provide services for file transfers, video, voice, e-mail, browsing, and the like. One exemplary application layer is Layer 7 of the Open System Interconnection (OSI) model. The application layer may transmit and/or receive information through the plurality of network interfaces as if the application layer was interacting with a single network interface over a single network connection, as will be discussed in detail below. Thus, the terminal 205 (and perhaps the terminal 210) is configured to access a plurality of first addresses associated with the plurality of network interfaces and form a second address associated with the plurality of first addresses. The second address may be associated with the application layer, or perhaps another network interface, as will be discussed in detail below.

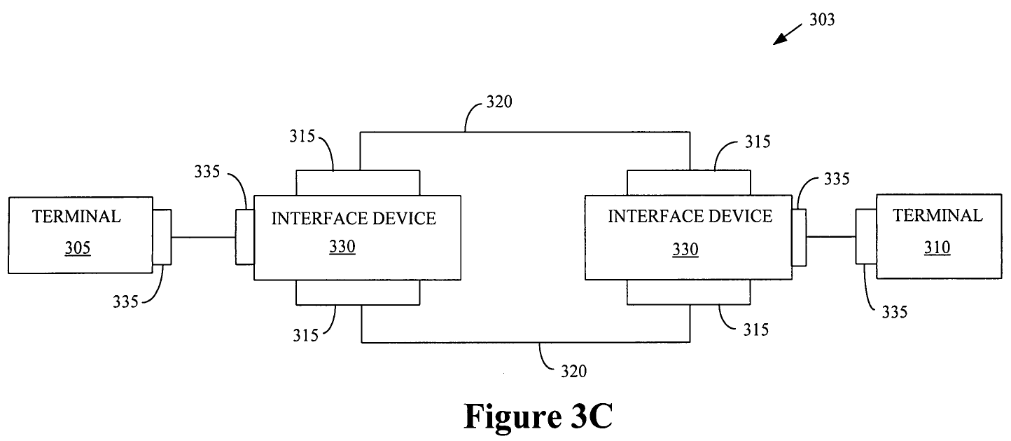

FIGS. 3A, 3B, and 3C conceptually illustrate three exemplary embodiments of wireless communication systems 301, 302, 303 that allow one or more terminals to communicate using a plurality of concurrent network connections via a plurality of network interfaces. In the interest of clarity, only two network connections will be shown in the exemplary embodiments of the wireless communication systems 301, 302, 303. However, persons of ordinary skill in the art having benefit of the present disclosure should appreciate that alternative embodiments of the present invention may include more than two network connections.

FIG. 3A conceptually illustrates the first exemplary embodiment of the wireless communication system 301. In the illustrated embodiment, the wireless communication system 301 includes two terminals 305, 310. Each of the terminals 305, 310 includes two network interfaces 315, which may be used to form two network connections 320 between the terminals 305, 310.

FIG. 3B conceptually illustrates the second exemplary embodiment of the wireless communication system 302. In the illustrated embodiment, the wireless communication system 302 includes two terminals 305, 310. The terminal 305 includes two network interfaces 315 and the terminal 310 includes a single network interface 315. Traffic associated with the two network connections 320 may be routed to a single communication link 325 by intermediate entities (not shown) in the wireless communication system 302.

FIG. 3C conceptually illustrates the third exemplary embodiment of the wireless communication system 303. In the illustrated embodiment, the wireless communication system 303 includes two terminals 305, 310 that are coupled to interface devices 330 via interfaces 335. The interface devices 330 each include two network interfaces 315. The network interfaces 315 may be used to form two network connections 320. Information is transmitted and/or received to the virtual network interface may be provided to an application layer in the terminals 305, 310 via the interfaces 335.

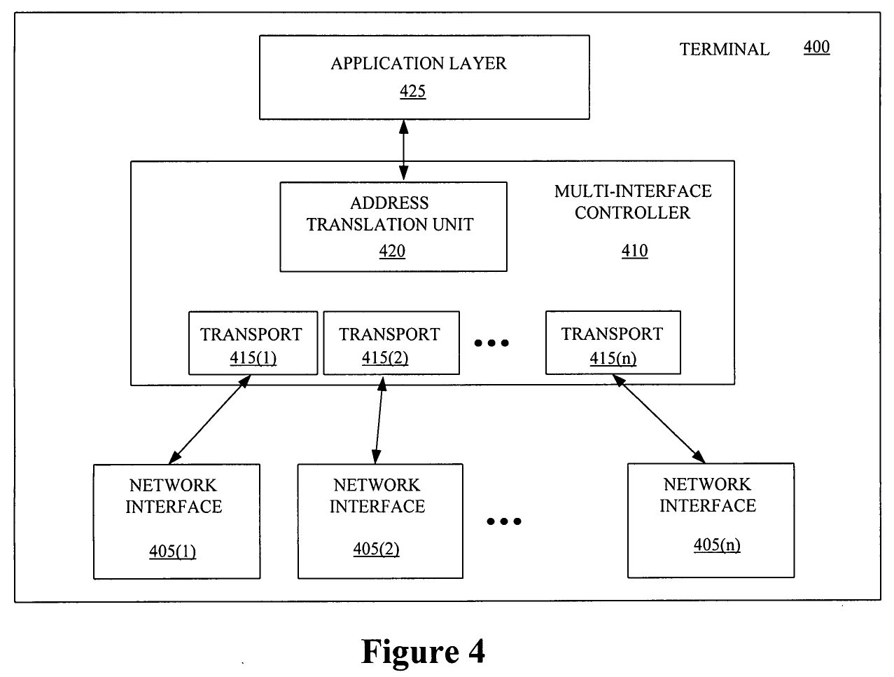

FIG. 4 conceptually illustrates one exemplary embodiment of a terminal 400 that may be used in the wireless communication systems 200, 301, 302, 303 shown in FIGS. 2 and 3A-C. In the illustrated embodiment, the terminal 400 includes a plurality of network interfaces 405(1-n). As discussed above, the number and/or type of network interface 405(1-n) are matters of design choice. For example, the terminal 400 may include one or more network interfaces 405(1-n) that may be used to interface with wired and/or wireless networks including, but not limited to, Internets, intranets, local area networks, UMTS networks, GSM networks, IEEE 802.11 networks, Bluetooth networks, and the like. In various alternative embodiments, the network interfaces 405(1-n) may be implemented in separate devices, may be combined in a single device, or in a combination of individual devices and combination devices. For example, a wireless local area network interface card may be capable of using multiple non-overlapping frequency channels to form more than one network connection. Each of these logically separated channels are associated with a corresponding network interface 405(1-n) and thus may be used in parallel, e.g., the network interfaces 405(1-n) may be used to form a plurality of concurrent network connections.

In one embodiment, the network interfaces 405(1-n) may be network interfaces for a Multiple-In-Multiple-Out (MIMO) network. For example, each network interface 405(1-n) may be associated with an antenna and/or a communication channel of the MIMO network. In some circumstances, such as when there is insufficient scattering in the vicinity of the MIMO base stations or other access networks, non-overlapping channels may be used.

A multi-interface controller 410 is used to control operation of the network interfaces 405(1-n). In one embodiment, the multi-interface controller 410 forms a plurality of transport sessions 415(1-n), which are associated with a corresponding one of the network interfaces 405(1-n). The transport sessions 415(1-n) may communicate with the network interfaces 405(1-n) by exchanging Network Data Units (NDUs). Although FIG. 4 shows a single transport session 415(1-n) associated with each network interface 405(1-n), persons of ordinary skill in the art should appreciate that the present invention is not so limited. In some embodiments, one or more of the transport sessions 415(1-n) may be associated with a network interface 405(1-n). Moreover, not every network interface 405(1-n) may have an associated transport session 415(1-n). For example, an idle network interface 405(1-n) may not have an associated transport session 415(1-n).

In one embodiment, the multi-interface controller 410 may be configured to form a virtual network interface using one or more of the network interfaces 405(1-n). Techniques for forming a virtual network interface are described in U.S. patent application Ser. No. 11/057,607, entitled “Method for Distributing Transport Sessions over Multiple Network Interfaces,” which is hereby incorporated herein in its entirety. In another embodiment, which may be practiced in addition to or separately from embodiments of the multi-interface controller 410 that implement the virtual network interface described above, the multi-interface controller 410 may be configured to distribute packets over concurrent network interfaces 405(1-n). Techniques for distributing packets to network interfaces 405(1-n) for transmission over the associated concurrent network connections are described in U.S. patent application Ser. No. __________, entitled “Distributing Information over Parallel Network Interfaces,” which is hereby incorporated herein in its entirety.

In the illustrated embodiment, the multi-interface controller 410 includes an address translation unit 420. The address translation unit 420 may be implemented in software, firmware, hardware, or any combination thereof. Moreover, persons of ordinary skill in the art having benefit of the present disclosure should appreciate that the present invention is not limited to address translation units 420 that are contained within the multi-interface controller 410. In alternative embodiments, portions of the address translation unit 420 may be implemented outside of the multi-interface controller 410.

The address translation unit 420 may be configured to translate addresses associated with one or more of the network interfaces 405(1-n) into a common address when one or more of the network interfaces 405 are used to form one or more concurrent network connections. For example, as will be discussed in detail below, the address translation unit 420 may translate network addresses associated with the network interfaces 405(1-2) into a single network address that may be associated with one or more applications residing in an application layer 425. For another example, as will be discussed in detail below, the address translation unit 420 may translate network addresses associated with the network interfaces 405(1-2) into a single network address that may be associated with the network interface 405(n). In one embodiment, the address translation unit 420 may also translate a common address (e.g., a network address associated with the application layer 425 and/or a network interface 405(1-n)) into one or more network addresses associated with the network interfaces 405(1-n).

The address translation unit 420 may translate the network addresses using any translation convention, technique, and/or algorithm. In one embodiment, the address translation unit 420 may associate the network address of one of the network interfaces 405(1-n) with the application layer 425. In one alternative embodiment, the address translation unit 420 may associate the application layer 425 with an address that is different than any of the network addresses associated with the network interfaces 405(1-n). The address translation unit 420 may also associate the application layer 425 with an IP network address from a private address space. In various embodiments, the application address can be assigned for a selected application or for all the applications residing in the application layer 425. The address translation unit 420 may, in some embodiments, maintain a translation table (not shown) that defines the relation between the application address and the network addresses and vice versa. The translation table may also include information indicative of one or more ports (not shown) of the terminal 400.

In operation, the multi-interface controller 410 may split traffic (e.g., information in the form of datagrams and/or packets) originating from the application layer 425 into different parts so that these parts may be transmitted using concurrent network connections associated with a plurality of the network interfaces 405(1-n). The address translation unit 420 translates the originating application address into network addresses associated with the network interfaces 405(1-n) that are used to originate the concurrent network connections. In one embodiment, the network addresses associated with the originating network interfaces 405(1-n) may be used by the multi-interface controller 410 to optimize the application information transfer over multiple interfaces.

The multi-interface controller 410 may also combine traffic associated with the application layer 425 that is arriving over concurrent network connections terminated by one or more of the network interfaces 405(1-n). The address translation unit 420 translates the network addresses associated with the network interfaces 405(1-n) that are used to terminate the concurrent network connections into an address associated with the application layer 425. In one embodiment, the address translation unit 420 may expose the address associated with the application layer 425 to the application layer 425.

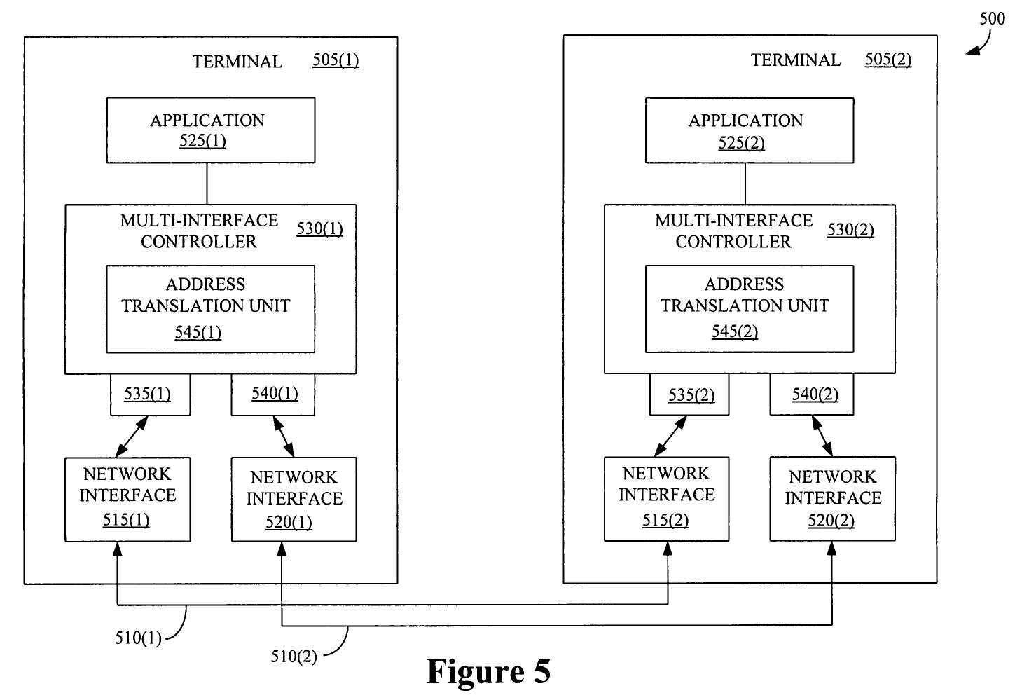

FIG. 5 conceptually illustrates a first exemplary embodiment of a communication system 500. In the illustrated embodiment, the communication system 500 includes terminals 505(1-2) that may communicate over one or more concurrent network connections 510(1-2), which are terminated at network interfaces 515(1-2), 520(1-2). The terminals 505(1-2) each include one or more applications 525(1-2) that may provide packets to and/or receive packets from a multi-interface controller 530(1-2). As discussed above, each multi-interface controller 530(1-2) may form a plurality of transport sessions 535(1-2), 540(1-2) which are each associated with a corresponding one of the network interfaces 515(1-2), 520(1-2). The terminals 505(1-2) also include address translation units 545(1-2) that may be used to form a single network address associated with one or more network addresses associated with the network interfaces 515(1-2), 520(1-2), or to translate a single network address into one or more network addresses associated with the network interfaces 515(1-2), 520(1-2).

In operation, the application 525(1) is associated with a first application address. The address translation unit 545(1) may associate a source address for traffic originating from the application 525(1) with the first application address. The address translation unit 545(1) in terminal 505(1) translates the source address to a first network address associated with the network interface 515(1) and a second network address associated with the network interface 520(1). For example, the address translation unit 545(1) may remove information indicative of the first application address from one or more packets and associate information indicative of the first or the second network address with the one or more packets.

In one embodiment, the address translation unit 545 may translate the source address into the first and second network addresses in accordance with an optimum distribution ratio of the application traffic over the network interfaces 515(1), 520(1). The optimum distribution ratio may be determined by the multi-interface controller 530. Traffic originating from the application 525(2) and arriving at network interfaces 515(1), 520(1) is combined and the address translation unit 545(1) translates the destination address information (e.g., the first and second network addresses associated with arriving packets) to the first application address associated with the application 525(1).

The application 525(2) is associated with a second application address. The address translation unit 545(2) may associate a source address for traffic originating from the application 525(2) with the second application address. The address translation unit 545(2) may then translate the source address to a third network address associated with the network interface 515(2) and a fourth network address associated with the network interface 520(2). Traffic originating from the application 525(1) and arriving at network interfaces 515(2), 520(2) is combined and the address translation unit 545(2) translates the destination address information (e.g., the first and second network addresses associated with arriving packets) to the second application address associated with the application 525(2). For example, the address translation unit 545(1) may remove information indicative of the first or second network addresses from one or more packets and associate information indicative of the first application address with the one or more packets.

The address translation units 545(1-2) may exchange information indicating the translations may be performed so that the opposite translations can be performed at the other end. Thus, in one embodiment, the address translation unit 545(1) may combine information associated with the third and fourth network addresses and translate these addresses to associate the information with the second application address, such that the information appears to originate from the second application address, i.e. the application 525(2). The address translation unit 545(2) may combine the information originating from the first and second network addresses and translate these addresses to the first application address.

In one embodiment, the address translation units 545(1-2) may translate the address information associated with all of the applications used in the communication between terminals 505(1-2). Alternatively, the address translation units 545(1-2) may translate the address information for information that is associated with a specific application, which may also involve translating port numbers associated with the specific application. In the illustrated embodiment, the address translations correspond to embodiments in which a routed network exists between the terminals 505(1-2). However, the present invention is not limited to routed networks. Persons of ordinary skill in the art having benefit of the present disclosure should appreciate that address translations may be performed in other network environments and that the network address translations may differ from one network environment to another. For example, routed public networks such as the Internet may have different requirements associated with different network addresses.

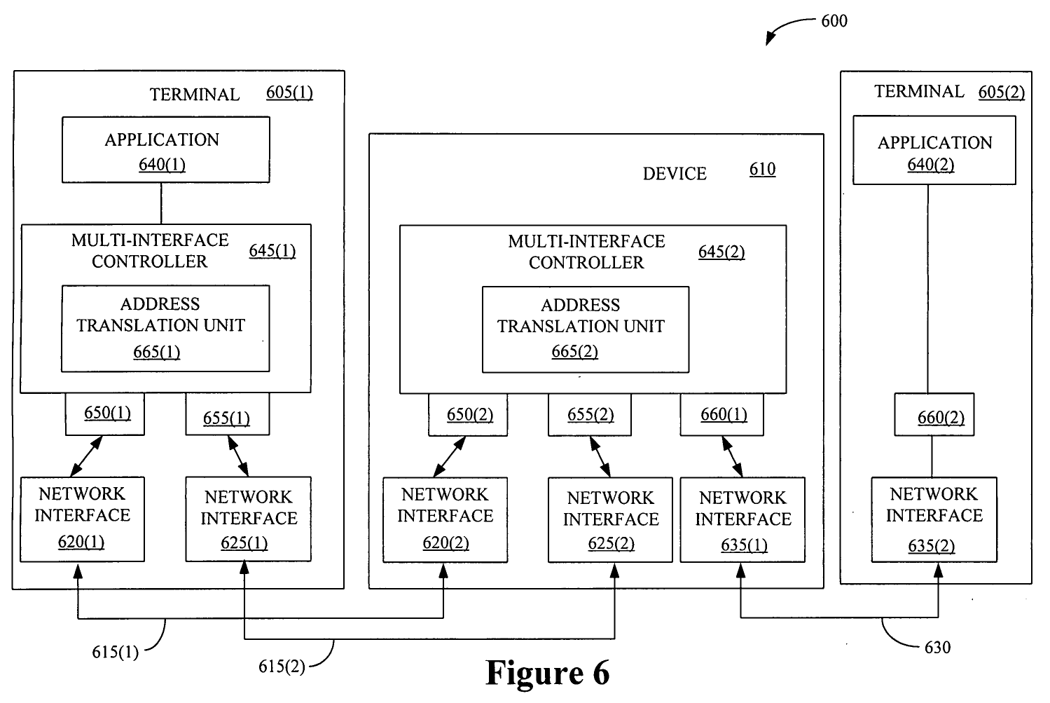

FIG. 6 conceptually illustrates a second exemplary embodiment of a communication system 600. In the illustrated embodiment, the communication system 600 includes terminals 605(1-2). The terminal 605(1) may communicate over one or more concurrent network connections 615(1-2), which are terminated at network interfaces 620(1-2), 625(1-2). In the illustrated embodiment, the terminal 605(2) may communicate over one or more concurrent network connections 630 that are terminated at network interfaces 635(1-2). The terminals 605(1-2) each include one or more applications 640(1-2) that may provide packets for transmission and/or receive packets over the network connections 615(1-2), 630.

The terminal 605(1) and device 610 each include a multi-interface controller 645(1-2). As discussed above, each multi-interface controller 645(1-2) may form a plurality of transport sessions 650(1-2), 655(1-2), 660(1-2) that are each associated with a corresponding one of the network interfaces 620(1-2), 625(1-2), 635(1-2). The multi-interface controllers 645(1-2) include address translation units 665(1-2) that may be used to form a single network address associated with one or more network addresses associated with the network interfaces 620(1-2), 625(1-2), 635(1-2), or to translate a single network addressi into one or more network addresses associated with the network interfaces 620(1-2), 625(1-2), 635(1-2).

In the illustrated embodiment, the applications 640(1-2) may communicate using the network connections 615(1-2), 630(1-2). In one embodiment, device 610 acts as an intermediate element that is traversed by all information transmitted between the terminals 605(1-2). For traffic originating in the application 640(1), the address translation unit 665(1) splits the application information and transmits the information to network interfaces 620(1), 625(1) using first and second network address associated with the network interfaces 620(1), 625(1) as the source addresses. Third and fourth network address associated with the network interfaces 620(2), 625(2) may be used as the destination addresses. The address translation unit 665(2) may combine the traffic arriving at network interfaces 620(2), 625(2) and transmit the combined traffic over transport session 660(1) to terminal 605(2). The traffic transmitted by transport session 660(1) is marked by a fifth network address (e.g., a source address) associated with the network interface 635(1) and a sixth network address (e.g., a destination address) associated with the network interface 635(2).

In one alternative embodiment, the device 610 acts as application gateway and appears as an application endpoint to the terminal 605(1). In this embodiment, the device 610 functions as an application gateway to terminals 605(1-2). For example, the application 640(1) may be configured to use a device address associated with the device 610 (e.g., an imaginary address or the fifth network address could be used) when using a service provided by the application 640(2). The device address may not be related to any network interface.

Application traffic on terminal 605(1) originates from the first application address associated with the application 640(1) and is destined for the device address. The address translation unit 665(1) translates the first application address to first and second network addresses associated with the network interfaces 620(1), 625(1) and splits the traffic. The destination address may be changed from the device address to third and fourth network addresses associated with the network interfaces 620(2), 625(2). The address translation unit 665(2) combines the traffic arriving at the network interfaces 620(2), 625(2) and changes the source address into the fifth network address associated with the network interface 635(1). The address translation unit 665(2) may also translate the destination address into the sixth network address associated with the network interface 635(2). Since the device 610 serves as application gateway, both terminals 605(1-2) may consider the device 610 as the communication end-point. In the illustrated embodiment, the address translation units 665(1-2) do not translate the network addresses to the application layer, but use the address translation to communicate over another network interface (e.g., the network interface 635(1)).

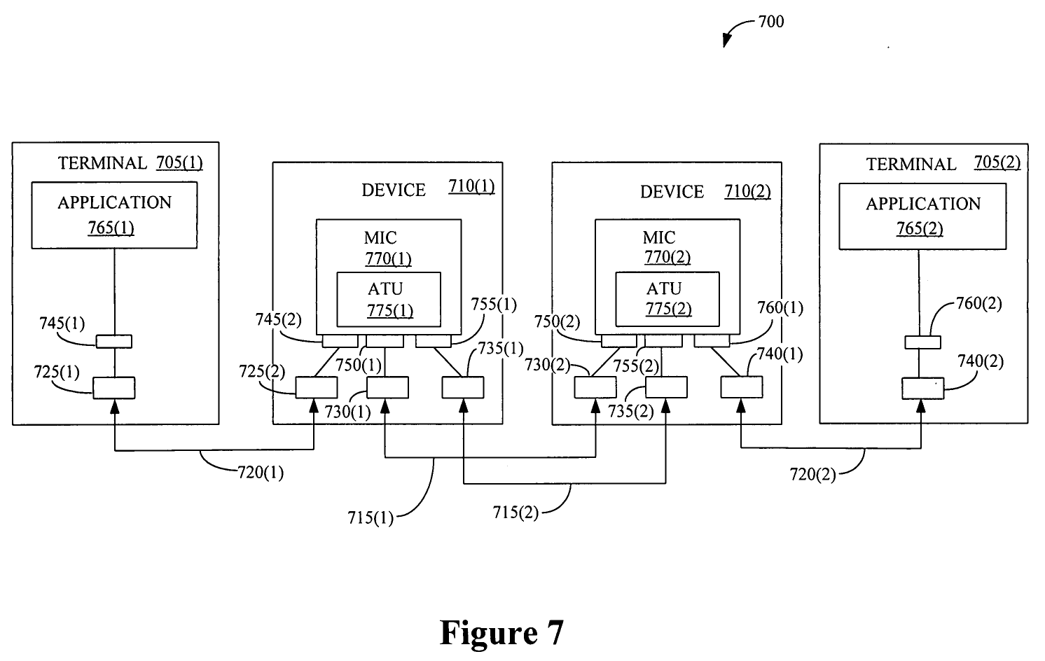

FIG. 7 conceptually illustrates a third exemplary embodiment of a communication system 700. In the illustrated embodiment, the communication system 700 includes terminals 705(1-2) and devices 710(1-2). Devices 710(1-2) communicate over one or more concurrent network connections 715(1-2), and the terminals 705(1-2) may communicate with the devices 710(1-2) via the network connections 720(1-2). The network connections 715(1-2), 720(1-2) are terminated at network interfaces 725(1-2), 730(1-2), 735(1-2), 740(1-2), which are associated with transport sessions 745(1-2), 750(1-2), 755(1-2), 760(1-2). The terminals 705(1-2) also include one or more applications 765(1-2). The devices 710(1-2) include a multi-interface controller 770(1-2), which includes an address translation unit 775(1-2).

In operation, the applications 765(1-2) may communicate via the devices 710(1-2). The address translation units 775(1-2) may provide address translations so that the applications 765(1-2) may transmit information via one or more of the concurrent network connections 715(1-2), 720(1-2), as discussed in detail above. For example, the devices 710(1-2) may act as an intermediate element that is traversed by all information transmitted between the terminals 705(1-2) and the address translation units 775(1-2) may translate the various addresses accordingly. For another example, one or more of the devices 710(1-2) may act as an application gateway and appear as an application endpoint to the associated terminal(s) 705(1-2). The address translation units 775(1-2) may then translate the various addresses accordingly, e.g. using one or more imaginary addresses or addresses associated with the network connections 725(1-2), 740(1-2). As discussed above, the network translation may depend on the network environment of the considered network devices 705(1-2), 710(1-2). However, in this example none of the address translation units 775(1-2) translate network addresses to the application layers 765(1-2). Instead, a network translation is made for the session to one of the terminals 705(1-2) and takes place just below the application layer 765(1-2).

Implementing one or more embodiments of the techniques described above may have a number of advantages over conventional practice. For example, a conventional Mobile Internet Protocol may provide additional Internet Protocol encapsulation to incorporate addresses associated with different layers in various devices. Consequently, Mobile IP solutions may impose additional overhead on each packet that is transmitted over the network connections. Furthermore, using Mobile IP for multiple network interfaces simultaneously may result in a solution that appears to the transport layer as a single network interface and therefore a single associated transport session may be split at the network layer. Consequently, optimum transport efficiency cannot be achieved, at least in part because the different network interfaces typically have different characteristics that are exposed to the same transport session, which cannot adapt sufficiently to accommodate all of the requirements of the different network interfaces. In contrast, the overhead associated with the techniques described above may be limited to exchanging translation information and/or ordering information, which is typically far less than the overhead associated with other network-layer oriented solutions (such as Mobile IP) that operate by re-encapsulating traffic. Furthermore, embodiments of the techniques described above may be implemented without affecting applications that can only be bound to one network identity. This development may allow the applications to be abstracted from the network layer aspects involved in optimizing the information transfer over multiple network interfaces.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What Is Claimed:

1. A method, comprising:
accessing information indicative of a plurality of first addresses associated with a plurality of first network interfaces; and
forming a second address associated with the plurality of first addresses.

2. The method of claim 1, wherein accessing said information indicative of the plurality of first addresses comprises accessing said information provided by the plurality of first network interfaces.

3. The method of claim 1, wherein forming the second address comprises selecting one of the plurality of first addresses.

4. The method of claim 1, wherein forming the second address comprises forming a second address that differs from each of the plurality of first addresses.

5. The method of claim 1, comprising associating the second address with each of the plurality of first network interfaces.

6. The method of claim 5, comprising associating the second address with at least one of an application and a second network interface.

7. The method of claim 5, comprising receiving at least one packet comprising information indicative of the second address.

8. The method of claim 7, comprising selecting at least one of the plurality of first network interfaces for transmitting said at least one packet.

9. The method of claim 8, comprising associating information indicative of at least one of the plurality of first addresses associated with the selected at least one of the plurality of first network interfaces with said at least one packet.

10. The method of claim 9, comprising removing said information indicative of the second address from said at least one packet.

11. The method of claim 10, comprising transmitting said at least one packet comprising said information indicative of at least one of the plurality of first addresses associated with the selected at least one of the plurality of first network interfaces.

12. A method, comprising:
forming a plurality of first addresses associated with a plurality of first network interfaces using a second address.

13. The method of claim 12, comprising accessing information indicative of the second address.

14. The method of claim 13, wherein accessing said information indicative of the second address comprises accessing said information provided by at least one of an application and a second network interface.

15. The method of claim 12, wherein forming the plurality of first addresses comprises setting one of the plurality of first addresses equal to the second address.

16. The method of claim 12, wherein forming the plurality of first addresses comprises forming the plurality of first addresses such that all of the first addresses are different than the second address.

17. The method of claim 12, comprising associating the second address with each of the plurality of first network interfaces.

18. The method of claim 12, comprising receiving at least one packet comprising information indicative of at least one of the plurality of first addresses from at least one of the plurality of network interfaces.

19. The method of claim 18, comprising associating information indicative of the second address said at least one packet.

20. The method of claim 19, comprising removing said information indicative of said at least one first address from said at least one packet.

21. The method of claim 20, comprising providing said at least one packet to at least one of an application and a second network interface based on the second address.
